(19) United States
(12) Patent Application Publication
(10) Pub. No.: US 2022/0092411 A1
(43) Pub. Date: Mar. 24, 2022

(54) DATA PREDICTION METHOD BASED ON GENERATIVE ADVERSARIAL NETWORK AND APPARATUS IMPLEMENTING THE SAME METHOD

(71) Applicant: SAMSUNG SDS CO., LTD., Seoul (KR)

(72) Inventors: Jaesun SHIN, Seoul (KR); Suk Hoon JUNG, Seoul (KR); Ki Hyo MOON, Seoul (KR)

(21) Appl. No.: 17/077,077

(22) Filed: Oct. 22, 2020

(30) Foreign Application Priority Data
Sep. 21, 2020 (KR) 10-2020-0121279

(51) Int. Cl. G06N 3/08; G06N 3/04; G06N 20/20

(52) U.S. Cl. CPC G06N 3/08; G06N 20/20; G06N 3/0454

(57) ABSTRACT

A data prediction method based on generative adversarial network (GAN) may be performed by a computing device. The data prediction method may include pre-training a generator neural network based on an auto encoder structure including an encoder and a decoder, and training a GAN including a discriminator neural network and the pre-trained generator neural network by a transfer learning method, wherein training the GAN by a transfer learning method includes training the GAN while fixing a decoder neural network of the generator neural network to the pre-trained initial state.

### CROSS-REFERENCE TO RELATED APPLICATIONS AND CLAIM OF PRIORITY

This patent application claims the benefit of Korean Patent Application No. 10-2020-0121279, filed on Sep. 21, 2020, which is hereby incorporated by reference in its entirety into this application.

### BACKGROUND

### 1. Field

The present invention relates to a data prediction method based on a generative adversarial network (GAN), and an apparatus for implementing the same, and in more detail, it relates to a data prediction method based on a generative adversarial network for predicting data using a generative adversarial network and an apparatus for implementing the same.

### 2. Description of the Related Art

A Generative Adversarial Network (GAN) is one of the machine learning methods that automatically creates images, videos, and voices that are close to the real world, and a generator neural network and a discriminator neural network compete each other and produce results similar to the real world.

However, the GAN often has a problem in that the generator neural network is not properly trained often because the learning speed of the generator neural network is slow compared to the discriminator neural network.

On the other hand, as a method for correcting a missing value, a method of deleting a data row having a missing value, replacing it with an average value or an arbitrary value, or predicting the missing value using machine learning has been used. These methods cause information loss and data distortion, making data analysis difficult.

Further, a generative adversarial imputation network (GAIN) is used as a correction technology for missing values using a GAN, and it is difficult to trust the trained results due to the difference in learning speed between the generator neural network and the discriminator neural network, which is an inherent problem of a GAN.

Therefore, in the case of correcting a missing value using a GAN, a correction method that minimizes information loss and provides reliable correction results is required.

### SUMMARY

The technical problem to be solved by the present invention is, in data prediction based on a GAN, to provide a GAN based data prediction method that can prevent learning failure by reducing the difference in learning speed between the generator neural network and the discriminator neural network and an apparatus for implementing the same.

Another technical problem to be solved by the present invention is, in correcting missing values based on a GAN, to provide a GAN based data prediction method that can provide reliable correction results while minimizing information loss and data distortion occurring when correcting a missing value, and an apparatus for implementing the same.

Another technical problem to be solved by the present invention is, in correcting a missing value based on a GAN, to provide a GAN based data prediction method that can measure information loss and contamination occurring during correction by evaluating the reliability of the corrected data, and an apparatus for implementing the same.

The technical problems of the present invention are not limited to the technical problems mentioned above, and other technical problems that are not mentioned will be clearly understood by those skilled in the art from the following description.

According to an aspect of the inventive concept, there is provided a data prediction method based on generative adversarial network (GAN) performed by a computing device. The method includes pre-training a generator neural network based on an auto encoder structure including an encoder and a decoder, and training a GAN including a discriminator neural network and the pre-trained generator neural network by a transfer learning method, wherein training the GAN by a transfer learning method includes, training the GAN while fixing a decoder neural network of the generator neural network to the pre-trained initial state.

According to another aspect of the inventive concept, there is provided a method, wherein pre-training a generator neural network based on an auto encoder structure including the encoder and decoder includes, training the auto encoder using a first data set for pre-training among original data.

According to another aspect of the inventive concept, there is provided a method, wherein pre-training a generator neural network based on an auto encoder structure including the encoder and decoder includes, separating and training a decoder neural network of the auto encoder for each of a categorical variable and a numerical variable.

According to another aspect of the inventive concept, there is provided a method, wherein pre-training a generator neural network based on an auto encoder structure including the encoder and decoder includes, processing data corresponding to any one type of the categorical variable and the numerical variable as input data for each of a plurality of nodes included in each layer of the decoder neural network.

According to another aspect of the inventive concept, there is provided a method, wherein training a GAN including the discriminator neural network and the pre-trained generator neural network by a transfer learning method includes, training the generator neural network based on a result of learning an encoder of the auto encoder using a second data set different from the first data set.

According to another aspect of the inventive concept, there is provided a method, wherein training the GAN while fixing a decoder neural network of the generator neural network to the pre-trained initial state includes, fixing a decoder of the auto encoder to an initial state and using as a decoder neural network of the generator neural network.

According to an aspect of the inventive concept, there is provided a data prediction method based on generative adversarial network (GAN) performed by a computing device. The method includes pre-training a generator neural network based on an auto encoder structure including an encoder and a decoder using a first data set not including a missing value, and training a GAN including a discriminator neural network and the pre-trained generator neural network by a transfer learning method using a second data set including a missing value, wherein training the GAN by a transfer learning method includes, training the GAN while fixing a decoder neural network of the generator neural network to the pre-trained initial state.

According to another aspect of the inventive concept, there is provided a method, wherein data, in which a missing value is not included among original data, is included as the first data set, and wherein data, in which a missing value is replaced with a predefined initial value from data including the missing value among the original data, is included as the second data set.

According to another aspect of the inventive concept, there is provided a method, wherein a missing value is replaced by an average value when the missing value included in the second data set is a numerical variable, and the missing value is replaced by a mode value when the missing value is a categorical variable.

According to another aspect of the inventive concept, there is provided a method, wherein pre-training a generator neural network based on an auto encoder structure including the encoder and the decoder using the first data set not including the missing value includes, separating and training a decoder neural network of the auto encoder for each of a categorical variable and a numerical variable of the first data set.

According to another aspect of the inventive concept, there is provided a method, wherein training a GAN including the discriminator neural network and the pre-trained generator neural network by a transfer learning method using the second data set including the missing value includes, training the generator neural network based on a result of learning an encoder of the auto encoder using the second data set.

According to another aspect of the inventive concept, there is provided a method, wherein training the GAN while fixing a decoder neural network of the generator neural network to the pre-trained initial state includes, fixing a decoder of the auto encoder to an initial state and using as a decoder neural network of the generator neural network.

According to an aspect of the inventive concept, there is provided a data missing value correction method performed by a computing device. The method includes training a generative adversarial network (GAN) including a generator neural network and a discriminator neural network using a first data set not including a missing value and a second data set including a missing value, and obtaining a correction value of a missing value of the second data set output from a generator neural network of the trained GAN, a reliability score for the correction value of the missing value output from a discriminator neural network of the trained GAN and corrected data including the first data set.

According to another aspect of the inventive concept, there is provided a method, wherein training a GAN including a generator neural network and a discriminator neural network using a first data set not including a missing value and a second data set including a missing value includes pre-training the generator neural network using the first data set.

According to another aspect of the inventive concept, there is provided a method, wherein obtaining a correction value of a missing value of the second data set output from a generator neural network of the trained GAN, a reliability score for the correction value of the missing value output from a discriminator neural network of the trained GAN and corrected data including the first data set includes, outputting a correction value of the missing value by iterating a process of updating missing values of the second data set a preset number of times during learning of the generator neural network.

According to another aspect of the inventive concept, there is provided a method, wherein obtaining a correction value of a missing value of the second data set output from a generator neural network of the trained GAN, a reliability score for the correction value of the missing value output from a discriminator neural network of the trained GAN and corrected data including the first data set includes, determining whether to further train the discriminator neural network based on a reliability score for the correction value of the outputted missing value.

According to another aspect of the inventive concept, there is provided a data prediction apparatus. The apparatus includes one or more processors, a communication interface for communicating with an external device, a memory for loading a computer program performed by the processor, and a storage for storing the computer program, wherein the computer program includes instructions for performing operations including, pre-training a generator neural network based on an auto encoder structure including an encoder and a decoder, and training a GAN including a discriminator neural network and the pre-trained generator neural network by a transfer learning method, wherein training the GAN by a transfer learning method includes, training the GAN while fixing a decoder neural network of the generator neural network to the pre-trained initial state.

According to another aspect of the inventive concept, there is provided an apparatus, wherein training a GAN including the discriminator neural network and the pre-trained generator neural network by a transfer learning method includes, training the generator neural network based on a result of learning an encoder of the auto encoder.

According to another aspect of the inventive concept, there is provided an apparatus, wherein training the GAN while fixing a decoder neural network of the generator neural network to the pre-trained initial state includes, fixing a decoder of the auto encoder to an initial state and using as a decoder neural network of the generator neural network.

According to another aspect of the inventive concept, there is provided an apparatus, wherein pre-training a generator neural network based on an auto encoder structure including the encoder and decoder includes, pre-training the generator neural network by using a first data set not including a missing value, wherein training a GAN including the discriminator neural network and the pre-trained generator neural network by a transfer learning method includes, training a GAN by a transfer learning method using a second data set, in which a missing value is replaced with a predefined initial value from data including the missing value.

### BRIEF DESCRIPTION OF THE DRAWINGS

FIGS. 1 and 2 are conceptual diagrams for describing an embodiment of the present invention.

FIG. 3 is a configuration diagram of a data prediction apparatus according to an embodiment of the present invention.

FIG. 4 is a hardware configuration diagram of an exemplary computing device capable of implementing methods in accordance with some embodiments of the present invention.

FIGS. 5 and 6 are flowcharts describing a GAN based data prediction method according to another embodiment of the present invention.

FIG. 7 is a flowchart describing a GAN based data prediction method according to another embodiment of the present invention.

FIG. 8 is a flowchart describing a method of correcting a data missing a value according to another embodiment of the present invention.

FIG. 9 is a flowchart illustrating a whole process of performing data prediction based on a GAN according to some embodiments of the present invention.

FIG. 10 is an example illustrating a structure of an auto encoder for pre-training according to some embodiments of the present invention.

FIG. 11 is an example illustrating a structure of a generator neural network among a GAN according to some embodiments of the present invention.

FIGS. 12 and 13 are examples illustrating an overall learning structure of a GAN according to some embodiments of the present invention.

FIGS. 14 and 15 are examples of a data set including a missing value and a data set, in which the missing value is corrected based on a GAN, according to some embodiments of the present invention.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present invention, when it is determined that the detailed description of the related well-known configuration or function may obscure the gist of the present invention, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

In addition, in describing the component of this invention, terms, such as first, second, A, B, (a), (b), can be used. These terms are only for distinguishing the components tram other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, some embodiments of the present invention will be described in detail with reference to the accompanying drawings.

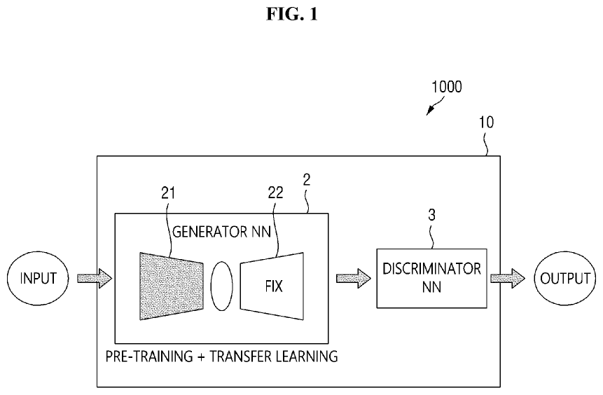

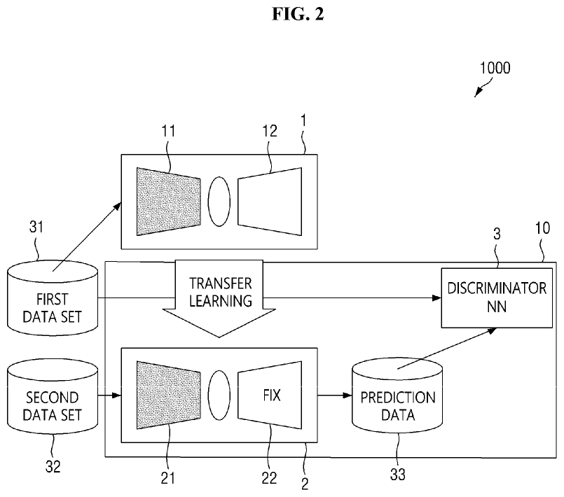

FIGS. 1 and 2 are conceptual diagrams for describing an embodiment of the present invention. Referring to FIG. 1, a data prediction apparatus 1000 according to an embodiment of the present invention predicts data based on a GAN 10.

In the illustrated example, the data prediction apparatus 1000 outputs prediction data for data input using the GAN 10 including a generator neural network 2 and a discriminator neural network 3.

As an embodiment, the data prediction apparatus 1000 may pre-train the generator neural network 2 based on an auto encoder structure. The data prediction apparatus 1000 may train the GAN 10 configured including the discriminator neural network 3 and the pre-trained generator neural network 2 by a transfer learning method.

At this time, in performing transfer learning, the data prediction apparatus 1000 may train the GAN 10 while fixing the decoder neural network 22 of the generator neural network 2 to the pre-trained initial state.

As described above, according to the data prediction apparatus according to an embodiment of the present invention, in data prediction based on a GAN, learning failure can be prevented by increasing the learning speed of the generator neural network and reducing the difference in the learning speed between the generator neural network and the discriminator neural network.

Referring to FIG. 2, a data prediction apparatus 1000 according to an embodiment of the present invention may pre-train the generator neural network 2 based on the structure of an auto encoder 1 including an encoder 11 and a decoder 12 using a first data set 31.

As an embodiment, when the pre-training of the generator neural network 2 is completed based on the structure of the auto encoder 1, the data prediction apparatus 1000 may train the pre-trained the generator neural network 2 by a transfer learning method.

In this case, in performing transfer learning, the data prediction apparatus 1000 may train the encoder neural network 21 of the generator neural network 2 by using the encoder 11 of the auto encoder 1 as an initial value.

Further, the data prediction apparatus 1000 fixes the decoder 12 of the pre-trained auto encoder 1 to an initial state without additional learning the decoder neural network 22 of the generator neural network 2 and use it as a decoder neural network 22 of the generator neural network 2. In this case, since the process of learning the decoder neural network 22 is omitted, the dimension is reduced by the learning of the encoder neural network 21 to increase the learning efficiency.

With the above structure, the data prediction apparatus 1000 may input the second data set 32 to the generator neural network 2, and as a result of training the generator neural network 2, obtain the prediction data 33 output from the generator neural network 2.

As an embodiment, the data prediction apparatus 1000 may train the discriminator neural network 3 by using the first data set 31 and the prediction data 33 output from the generator neural network 2. That is, the data prediction apparatus 1000 may input the first data set 31 and the prediction data 33 to the discriminator neural network 3, and as a result of training the discriminator neural network 3, obtain a probability value as to whether the prediction data 33 is distinguished from the first data set 31 which is actual data.

As another embodiment, the data prediction apparatus 1000 uses data output from the encoder 11 of the auto encoder 1 trained using the first data set 31 and data output from the encoder neural network 21 of the generator neural network 2 trained by the transfer learning method using the second data set 32 to train the discriminator neural network 3. In this case, the data prediction apparatus 1000 may input the data output from the encoder 11 of the auto encoder 1 and the data output from the encoder neural network 21 of the generator neural network 2 to the discriminator neural network 3, and as a result of training the discriminator neural network 3, obtain a probability value as to whether the data output from the generator neural network 2 is distinguished from the data output from the encoder 11 of the auto encoder 1.

As described above, the data prediction apparatus 1000 according to the embodiment of the present invention may perform data prediction based on the GAN 10, and provide information on whether the prediction data is distinguished from the actual data. Further, the data prediction apparatus 1000 solves the problem that the learning speed of the generator neural network is slow by the discriminator neural network in the process of performing data prediction based on the GAN 10 to perform proper learning.

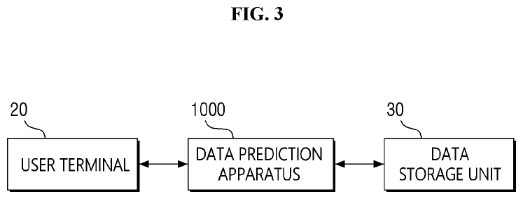

FIG. 3 is a configuration diagram of a data prediction apparatus according to an embodiment of the present invention.

Referring to FIG. 3, the data prediction apparatus 1000 processes a data analysis request received from the user terminal 20 and provides the result according to an embodiment of the present invention.

The data prediction apparatus 1000 is a fixed computing device and is connected to the user terminal 20 and the data storage unit 30 through a network. The data prediction apparatus 1000 perform analysis for data prediction by using data stored in the data storage unit 30 in response to data prediction request received from the user terminal 10. The data prediction apparatus 1000 may be implemented as a machine learning dedicated apparatus capable of executing statistical analysis and artificial intelligence algorithms.

The user terminal 20 may be, for example, any one of a fixed computing device such as a personal desktop PC, or a portable computing device such as a smart phone, a tablet PC, a laptop PC and a PDA. The user terminal 20 can be implemented as an administrator's terminal or an employee's terminal that requests the data prediction apparatus 1000 to analyze data on the data stored in the data storage unit 30, and makes a decision using the data analysis result provided from the data prediction apparatus 1000.

The data storage unit 30 may be implemented as a separate external device or a DB server connected to the data prediction apparatus 1000 through a network, and may store data generated in a business environment in various fields.

In this case, the data stored in the data storage unit 30 may include a data set consisting of at least one numerical variable and a categorical variable. Here, each of the numerical variable and the categorical variable may be used as an input variable for data analysis or prediction.

Further, the data stored in the data storage unit 30 may include a missing value generated due to various factors such as an input error and non-response.

The data prediction apparatus 1000 may receive data from the data storage unit 30 on a predetermined period basis or may request necessary data from the data storage unit 30 whenever a request is occurred from the user terminal 20.

The data prediction apparatus 1000 may perform an analysis for data prediction by using the data transmitted from the data storage unit 30 and provide the analysis result therefrom to the user terminal 20.

The data prediction apparatus 1000 may store all information related to data analysis such as variable information related to numerical variables and categorical variables used in data analysis, information on an analysis model generated for data prediction, and result information provided based on a learning result of the analysis model, etc.

As an embodiment, the data prediction apparatus 1000 may train a GAN using data provided from the data storage unit 30 and data processed through a preprocessing process according to the request of the user terminal 20 and obtain a prediction result output from the trained GAN.

Here, the data prediction apparatus 1000 may pre-train a generator neural network based on an auto encoder structure in the process of training a GAN, and train a GAN including a discriminator neural network and a pre-trained generator neural network by a transfer learning method.

In this case, the decoder neural network of the generator neural network may train the GAN in a state fixed to the pre-trained initial state.

As described above, by the configuration of the data prediction apparatus 1000 according to an embodiment of the present invention, in data prediction based on a GAN, a problem, in which the learning speed of the generator neural network is slow compared to that of the discriminator neural network, is solved and optimal learning can be achieved.

For example, the computer program 105 may include instructions for performing operations including pre-training the generator neural network 2 based on the auto encoder 1 structure including the encoder 11 and the decoder 12, and training the GAN 10 including the discriminator neural network 3 and the pre-trained generator neural network 2 by a transfer learning method.

As an embodiment, the operation of training the GAN including the discriminator neural network 3 and the pre-trained generator neural network 2 by the transfer learning method may include the operation of training the generator neural network 2 based on the result of learning the encoder 11 of the auto encoder 1.

As an embodiment, the operation of training the GAN 10 in a state, in which the decoder neural network 21 of the generator neural network 2 is fixed to the pre-trained initial state, may include the operation of fixing the decoder 12 of the auto encoder 1 to an initial state and using as the decoder neural network 22 of the generator neural network 2.

As described above, according to the computing device 100 according to an embodiment of the present invention, in data prediction based on a GAN, learning failure can be prevented by solving the problem in that the learning speed of the generator neural network is slow compared to that of the discriminator neural network and reducing the difference of learning speed.

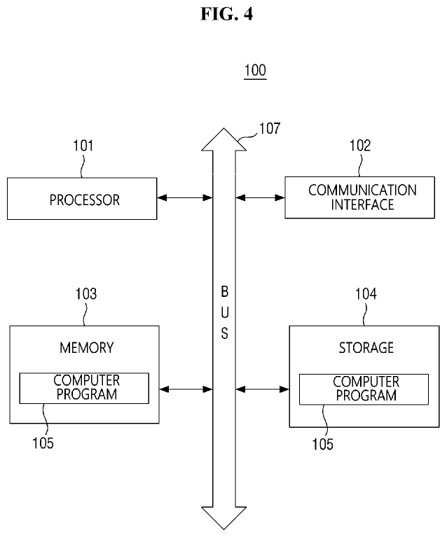

FIG. 4 is a configuration diagram showing the hardware configuration of an exemplary computing device 100.

Referring to FIG. 4, the computing device 100 may include one or more processors 101, a bus 107, a communication interface 102, a memory 103, which loads a computer program 105 executed by the processors 101, and a storage 104 for storing the computer program 105. However, FIG. 4 illustrates only the components related to the embodiment of the present disclosure. Therefore, it will be appreciated by those skilled in the art that the present disclosure may further include other general purpose components in addition to the components shown in FIG. 4.

The processor 101 controls overall operations of each component of the computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure, the computing device 100 may have one or more processors.

The memory 103 stores various data, instructions and/or information. The memory 103 may load one or more programs 105 from the storage 104 to execute methods/operations according to various embodiments of the present disclosure. For example, when the computer program 105 is loaded into the memory 103, the logic (or the module may be implemented on the memory 103. An example of the memory 103 may be a RAM, but is not limited thereto.

The bus 107 provides communication between components of the computing device 100. The bus 107 may be implemented as various types of bus such as an address bus, a data bus and a control bus.

The communication interface 102 supports wired and wireless internet communication of the computing device 100. The communication interface 102 may support various communication methods other than internet communication. To this end, the communication interface 102 may be configured to include a communication module well known in the art of the present disclosure.

The storage 104 can non-temporarily store one or more computer programs 105. The storage 104 may be configured to include a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 105 may include one or more instructions, on which the methods/operations according to various embodiments of the present disclosure are implemented. When the computer program 105 is loaded on the memory 103, the processor 101 may perform the methods/operations in accordance with various embodiments of the present disclosure by executing the one or more instructions.

For example, the computer program 105 may include instructions for performing operations including, pre-training a generator neural network based on an auto encoder structure including an encoder and a decoder, and training a GAN including a discriminator neural network and the pre-trained generator neural network by a transfer learning method, wherein training the GAN by a transfer learning method includes, training the GAN while fixing a decoder neural network of the generator neural network to the pre-trained initial state.

As an embodiment, the operation of training a GAN including the discriminator neural network and the pre-trained generator neural network by a transfer learning method includes, training the generator neural network based on a result of learning an encoder of the auto encoder.

As an embodiment, the operation of training the GAN while fixing a decoder neural network of the generator neural network to the pre-trained initial state includes, fixing a decoder of the auto encoder to an initial state and using as a decoder neural network of the generator neural network.

As an embodiment, the operation of pre-training a generator neural network based on an auto encoder structure including the encoder and decoder includes, pre-training the generator neural network by using a first data set not including a missing value, wherein training a GAN including the discriminator neural network and the pre-trained generator neural network by a transfer learning method includes, training a GAN by a transfer learning method using a second data set, in which a missing value is replaced with a predefined initial value from data including the missing value.

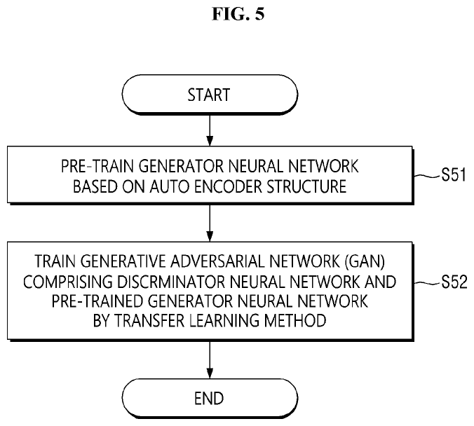

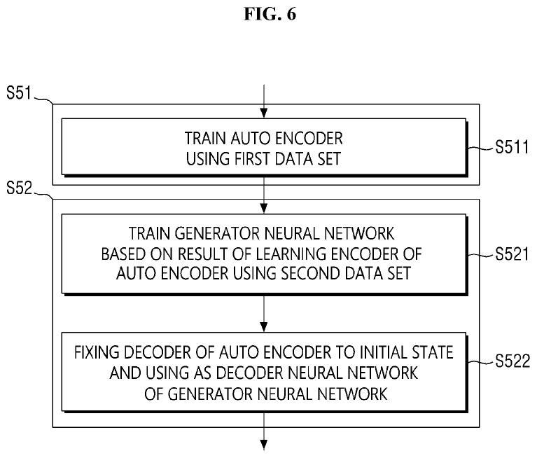

FIGS. 5 and 6 are flowcharts describing a data prediction method based on a GAN according to another embodiment of the present invention.

The data prediction method according to the present embodiment may be executed by the computing device 100, for example, by the data prediction apparatus 1000. The computing device 100 executing the method according to the present embodiment may be a computing device having a program development environment or a computing device having an application program execution environment. It should be noted that a description of a subject performing some operations included in the method according to the present embodiment may be omitted, and in such a case, the subject is the computing device 100.

Referring to FIGS. 5 and 6, first, in operation S51, a generator neural network 2 based on an auto encoder 1 structure including an encoder 11 and a decoder 12 is pre-trained.

Here, operation S51 may include an operation S511, in which the auto encoder 1 is trained using the first data set 31 for pre-training among the original data 300.

As an embodiment, operation S511 may include an operation, in which the decoder neural network 12 of the auto encoder 1 is separated and trained for each of the categorical variable and the numerical variable of the first data set 3. In this case, each of the plurality of nodes included in each layer of the decoder neural network 12 may process data corresponding to any one type of a categorical variable and a numerical variable as input data.

Next, in operation S52, a GAN 10 including the discriminator neural network 3 and the pre-trained generator neural network 2 is trained by a transfer learning method. At this time, prediction data similar to actual data is output from the trained generator neural network 2 among the GAN 10, and information on whether the prediction data is distinguished from the actual data may be output from the trained discriminator neural network 3.

As an embodiment, operation S52 may include operation S521, in which the generator neural network 2 is trained based on the result of leaning the encoder 11 of the auto encoder 1 using the second data set 32 different from the first data set 31. That is, prior to training the GAN 10, the generator neural network 2 can be configured by training the encoder 11 of the auto encoder 1 using the first data set 31 and transferring the pre-trained auto encoder 1.

Further, operation S52 may include operation S522, in which the decoder 12 of the auto encoder 1 is fixed to an initial state and used as the decoder neural network 22 of the generator neural network 2.

That is, in configuring the generator neural network 2 by transferring the result of learning the auto encoder 1, the encoder neural network 21 of the generator neural network 2 may perform learning by using the encoder 11 of the pre-trained auto encoder 1 as the initial value, and the decoder neural network 22 of the generator neural network 2 may not perform learning by using the decoder 12 of the pre-trained auto encoder 1 fixed to the initial state.

According to the above embodiment, in predicting data based on the GAN 10, there is an effect of preventing learning failure by reducing the difference in the learning speed between the generator neural network 2 and the discriminator neural network 3. That is, by adding a process of pre-training the generator neural network 2, the learning accuracy can be increased by improving the learning speed of the generator neural network 2 and balancing the learning speed with the discriminator neural network 3.

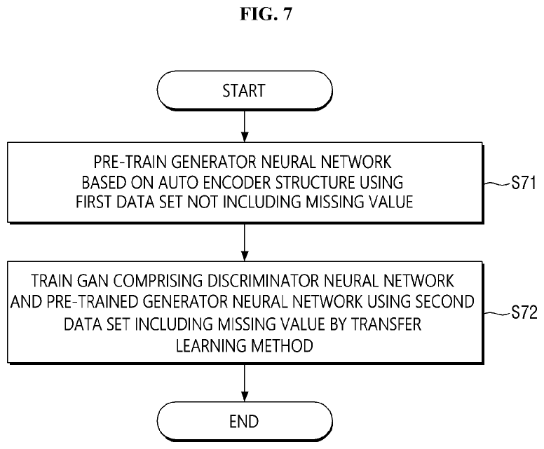

FIG. 7 is a flowchart describing a data prediction method based on a GAN according to another embodiment of the present invention. The data prediction method according to the present embodiment may be executed by the computing device 100, for example, by the data prediction apparatus 1000. The computing device 100 executing the method according to the present embodiment may be a computing device having a program development environment or a computing device having an application program execution environment. It should be noted that a description of a subject performing some operations included in the method according to the present embodiment may be omitted, and in such a case, the subject is the computing device 100.

Referring to FIG. 7, first, in operation S71, the generator neural network 2 is pre-trained based on the structure of an auto encoder 1 including an encoder 11 and a decoder 12 using a first data set 31 not including a missing value. As an embodiment, in operation S71, the decoder neural network 12 of the auto encoder 1 may be separated and trained for each of the categorical variable and the numerical variable of the first data set 31.

Next, in operation S72, a GAN 10 including a discriminator neural network 3 and a pre-trained generator neural network 2 is trained by this transfer learning method using the second data set 32 including a missing value. At this time, operation S72 may include an operation, in which the encoder neural network 21 of the generator neural network 2 is trained based on the result of training the encoder 11 of the auto encoder 1 using the second data set 32, and an operation, in which the decoder 12 of the auto encoder 1 is fixed to an initial state and used as the decoder neural network 22 of the generator neural network 2.

Here, the first data set 31 may include data that does not include missing values among the original data 30), and the second data set 32 may include data, in which a missing value is replaced with a predefined initial value from the data including the missing value among the original data. In this case, when the missing value included in the second data set 32 is a numerical variable, the missing value may be replaced by an average value, and when the missing value is a categorical variable, the missing value may be replaced by a mode value.

In training a GAN using data including missing values as described above, the learning speed of the generator neural network 2, which is slow compared to the discriminator neural network 3, can be increased by applying the pre-trained auto encoder 1 to the generator neural network 2 using data that does not include missing values and performing transfer learning.

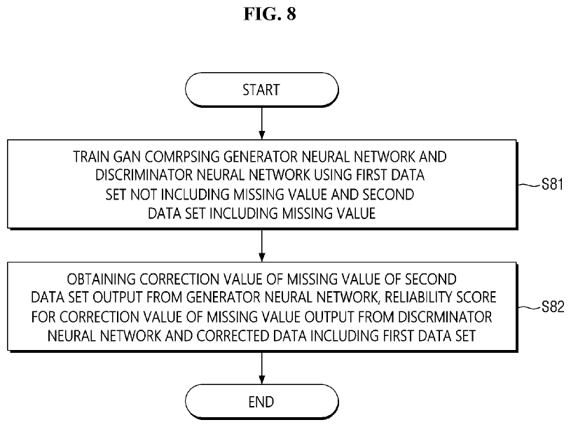

FIG. 8 is a flowchart describing a data missing value correction method according to another embodiment of the present invention. The data prediction method according to the present embodiment may be executed by the computing device 100, for example, by the data prediction apparatus 1000. The computing device 100 executing the method according to the present embodiment may be a computing device having a program development environment or a computing device having an application program execution environment. It should be noted that a description of a subject performing some operations included in the method according to the present embodiment may be omitted, and in such a case, the subject is the computing device 100.

Referring to FIG. 8, first, in operation S81, a GAN 10 including a generator neural network 2 and a discriminator neural network 3 is trained using a first data set 31 not including missing values and a second data set 32 including missing values. In this case, operation S81 may include an operation, in which the generator neural network 2 is pre-trained using the first data set 31.

Next, in operation S82, the correction value of the missing value of the second data set 32 output from the generator neural network 2 of the trained GAN 10, the reliability score for the correction value of the missing value output from the discriminator neural network 3 of trained GAN 10 and the corrected data including the first data set 31 are obtained.

As an embodiment, operation S82 may include an operation, in which a correction value of a missing value is output by iterating a process of updating missing values of the second data set 32 during learning of the generator neural network 2 a preset number of times.

Further, in operation S82, the discriminator neural network 3 is trained using the correction value of the missing value of the second data set 32 output from the generator neural network 2 and the first data set 31, and a probability value as to whether the correction value of the missing value is distinguished from the actual data may be output from the trained discriminator neural network 3. From this, a reliability score for the correction result of the missing value can be calculated.

For example, the reliability score for the correction result of the missing value may be calculated by using the difference between two probability distributions of the first data set 31 not including missing values and the correction value of the missing value of the second data set 32.

As an embodiment, in operation S82, whether or not to further train the discriminator neural network 3 may be determined based on a reliability score for a correction value of a missing value output from the discriminator neural network 3. That is, when the reliability score for the correction value of the missing value is low, it is determined that the correction value of the missing value is predicted not to be similar to the actual data, and additional learning of the discriminator neural network 3 may be performed. On the other hand, when the reliability score for the correction value of the missing value is high, it is determined that the correction value of the missing value is predicted similarly to the actual data, and additional learning may not be performed.

As described above, according to the data missing value correction method according to an embodiment of the present invention, in correcting the missing value based on a GAN, information loss and contamination occurring during correction can be measured quantitatively by evaluating the reliability of the corrected data. Further, by evaluating the reliability of the corrected data, it is possible to perform data analysis using more accurate data through optimal learning.

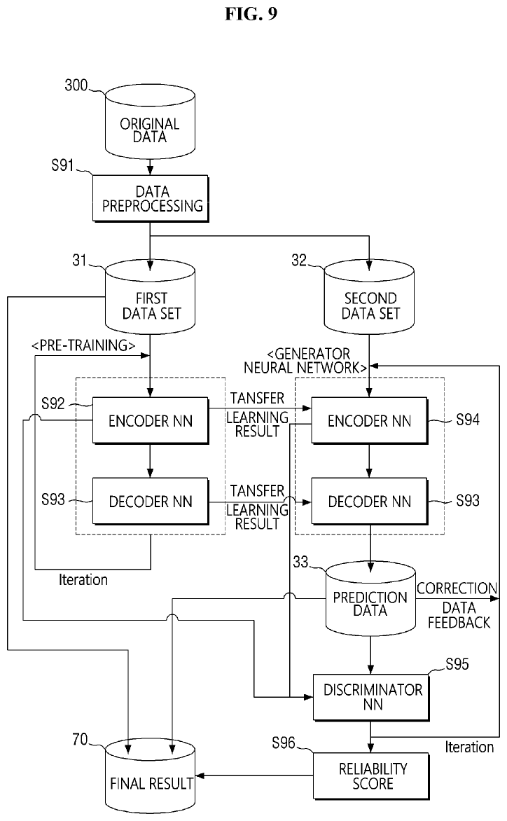

FIG. 9 is a flowchart illustrating a whole process of performing data prediction based on a GAN according to some embodiments of the present invention. FIG. 9 includes the whole process of training a GAN using data including missing values in relation to the embodiment described with reference to FIGS. 7 and 8.

Referring to FIG. 9, in operation S91, a first data set 31 and a second data set 32 are extracted from the original data 300 through data preprocessing.

In this case, the data preprocessing may include normalization processing for the numerical variable included in the original data 300 and one-hot encoding processing for the categorical variable. Here, the normalization process is to convert the data corresponding to the numerical variable to have the same unit with an average of 0 and a variance of 1. Through the normalization process, it becomes possible to compare several numerical data in the same unit.

The one-hot encoding represents a categorical variable as a binary vector, and is also called a dummy variable. For example, one-hot encoding displays categorical variables as binary vectors of integers 1 and 0, and expresses not-corresponding items as false values of 0, and corresponding items as true values of 1.

As an embodiment, the first data set 31 may be data that does not include missing values among the original data 300, and the second data set 32 may be data including the missing values among the original data 300.

In operation S91, a missing value may be replaced with a predefined initial value through data preprocessing in the second data set 32. For example, if a missing value corresponds to an observation value of a numerical variable, the missing value can be replaced by the mean value or the number zero (0), and if the missing value corresponds to an observation value of a categorical variable, the missing value can be replaced by the mode value.

Next, as a pre-training process, operations S92 and S93 are performed. In operation S92, the encoder 11 of the auto encoder 1 is trained, and in operation S93, the decoder 12 of the auto encoder 1 is trained. At this time, the encoder 11 and the decoder 12 of the auto encoder 1 may repeatedly perform learning until the number of updates reaches a preset maximum iteration number.

Next, as a learning process of the generator neural network 2 of the GAN, operations S94 and S93 are performed. In operation S94, the encoder neural network 21 of the generator neural network 2 is trained by transferring the learning result of the encoder 11 of the auto encoder 1 trained in operation S92. At this time, the encoder neural network 21 of the generator neural network 2 may perform learning by setting the encoder 11 previously trained in operation S92 to an initial value.

Meanwhile, the decoder neural network 22 of the generator neural network 2 may fix the decoder 12 trained in operation S93 to an initial state and use it. That is, the decoder neural network 22 uses the decoder 12 previously trained in operation S93 as it is, and does not perform additional learning.

As the learning process of the generator neural network 2, when operations S94 and S93 are performed, prediction data 33 for the second data set 32 is output from the trained generator neural network 2. Here, the prediction data 33 may be a correction value for a missing value of the second data set 32.

At this time, when training the generator neural network (2), the weights of the generator neural network 2 are updated in the direction of reducing the reconstruction error, and if the loss error is less than the threshold, the prediction data 33 of the second data set 32 is updated using Hadamard Product. At this time, the generator neural network 2 may be repeatedly trained until the number of updates reaches a preset maximum number of iterations. Through this process, the correction value of the missing value corresponding to the prediction data 33 may be updated.

Next, in operation S95, by using the data output from the encoder neural network 21 of the generator neural network 2 by operation S94 and the data output from the encoder 11 of the auto encoder 1 by operation S92, the discriminator neural network 3 is trained. In operation S95, when training the discriminator neural network 3, the weights of the discriminator neural network 3 are updated in a direction to reduce the discriminator error, through this, information on whether the data output from the encoder neural network 21 of the generator neural network 2 is distinguished from the data output from the encoder 11 of the auto encoder 1 is output.

In operation S96, a reliability score for the prediction data 33 is calculated using the information output in operation S95. As an example, the reliability score for the prediction data 33 may be calculated using the difference between two probability distributions of the first data set 31 not including missing values and the prediction data 33 including correction values for the missing values.

Finally, in operation S70, as the final result by training of the GAN, the correction value of the missing value included in the prediction data 33, the reliability score, and the first data set 31 that is normal data are obtained.

From this, the final result obtained through learning of the GAN can be utilized when analyzing data.

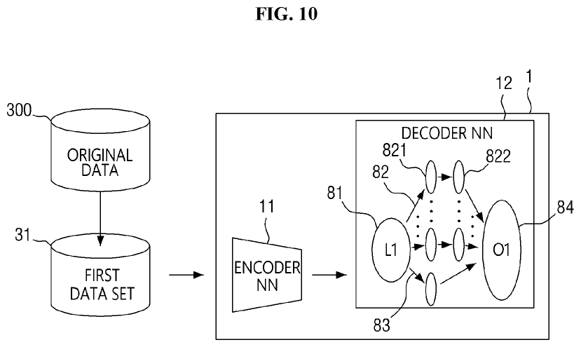

FIG. 10 is an example illustrating a structure of an auto encoder for pre-training according to some embodiments of the present invention. Referring to FIG. 10, the data prediction apparatus 1000 according to the embodiment of the present invention may train the auto encoder 1 using the first data set 31 extracted from the original data 300 as a pre-training process. Here, the first data set 31 may be data not including missing values.

At this time, when extracting the first data set 31, as a preprocessing process for the original data 300, normalization processing for numerical variables and one-hot encoding processing for categorical variables may be performed.

The auto encoder 1 may include an encoder neural network 11 for reducing the dimension of the first data set 31 and a decoder neural network 12 for recovering the reduced dimension.

In the illustrated example, when the first data set 31 is input to the encoder neural network 11, the reduced dimensional data is output from the trained encoder neural network 11, and the output data may be input to the decoder neural network 12 through a latent layer 81.

The decoder neural network 12 may include a plurality of layers connecting the latent layer 81 and the output layer 84. For example, when the type of the variable is categorical, the decoder neural network 12 may include, for example, a dense layer 821, which is a basis for learning, and an activation layer 822 added for class classification. Here, the activation layer 822 may use, for example, an activation function such as sigmoid and softmax for class classification.

As an embodiment, the decoder neural network 12 may separate and learn input data according to the type of variable. For example, the type of variable can be classified into a categorical variable 82 and a numerical variable 83, and the decoder neural network 12 can be separated and trained for each type of variable.

As an embodiment, when the type of the variable is the categorical variable 82, it may be learned by the first node group including at least one predetermined node among nodes included in each of a plurality of layers constituting the decoder neural network 12, when the type of the variable is the numerical variable 83, it may be learned by the second node group including nodes that do not belong to the first node group among nodes included in each of the plurality of layers.

Accordingly, the categorical variable 82 input through the latent layer 81 may be output to the output layer 84 with a result of recovering the dimension through learning by the first node group. Likewise, the numerical variable 83 input through the latent layer 81 may be output to the output layer 84 with a result of recovering the dimension through learning by the second node group.

As described above, the process of training the encoder neural network 11 and the decoder neural network 12 of the auto encoder 1 using the first data set may be performed until the number of updates of the neural network reaches a preset maximum number of iterations. From this, pre-training for training the GAN based on the auto encoder structure may be completed.

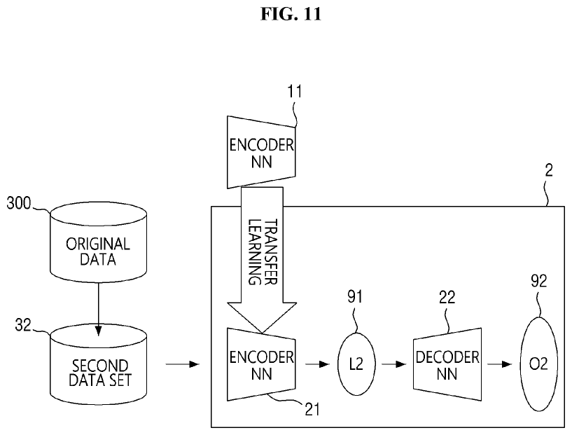

FIG. 11 is an example of a structure of a generator neural network among a GAN according to some embodiments of the present invention.

Referring to FIG. 11, a data prediction apparatus 1000 according to an embodiment of the present invention may train the generator neural network 2 using a second data set 32 extracted from the original data 300 as a learning process of the GAN 10. Here, the second data set 32 may be data including missing values.

Here, in the case that the second data set 32 is data including missing values, it may be used as training data by replacing the missing values with a predefined initial value. For example, when a missing value corresponds to an observation value of a numerical variable, the missing value is replaced by an average value, and when the missing value corresponds to an observation value of a categorical variable, the missing value may be replaced by a mode value.

In the illustrated example, the initial generator neural network 2 may be configured in a manner of transferring the encoder neural network 11 of the pre-trained auto encoder 1 using the first data set 31. That is, the training of the generator neural network 2 is limited and applied to the encoder neural network 21, and the encoder neural network 21 may be trained by setting the pre-trained encoder neural network 11 to an initial value. In this case, the decoder neural network 22 may be used by fixing the pre-trained decoder neural network 12 to an initial state without a learning process. As described above, the data prediction apparatus 1000 according to an embodiment of the present invention trains only the encoder neural network 21, and the decoder neural network 22 is fixed to the pre-trained initial state, thereby reducing the learning target dimension and increasing learning efficiency.

As an embodiment, weights of the generator neural network 2 may be updated in a direction to reduce a reconstruction error. In this case, when the loss error is less than the threshold value, prediction data 33 for the second data set 32 may be updated using a Hadamard Product. Hadamard Product is an operation that multiplies each component of two matrices of the same dimension, and is an effective operation technique for analyzing large amounts of data.

The prediction data 33 may be output through the output layer 92 after the generator neural network 2 is trained by a preset maximum number of iterations using the second data set 32. Here, the prediction data 33 may be a correction value for a missing value included in the second data set 32.

According to the embodiment of the present invention as described above, the second data set 32 is input to the encoder neural network 21 of the generator neural network 2 and is trained, and the reduced dimensional data may be output from the trained encoder neural network 21. Further, the output data is input to the decoder neural network 22 through the latent layer 91, and the prediction data 33 for the second data set 32 may be output from the decoder neural network 22 through the output layer 92.

As described above, when transfer learning for the generator neural network 2 is completed based on the encoder 11 of the pre-trained auto encoder 1, a correction value of the missing value may be output as the prediction data 33 for the second data set 32 including the missing values in the trained generator neural network 2.

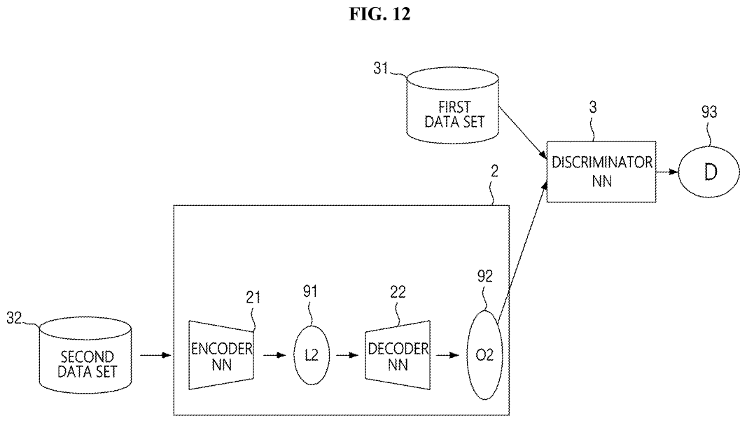

FIG. 12 is an example illustrating an overall learning structure of a GAN according to some embodiments of the present invention.

Referring to FIG. 12, the data prediction apparatus 1000 according to an embodiment of the present invention may train the discriminator neural network 3 using the prediction data 33 output from the generator neural network 2 and the first data set 31 as a learning process of the GAN 10, 1. Here, the prediction data 33 may be a correction value for a missing value.

In the illustrated example, the discriminator neural network 3 is trained using the correction value of the missing value of the second data set 32 output from the generator neural network 2 and the first data set 31, and a probability value on whether the correction value of the missing value is distinguished from the actual data may be output 93 from the trained discriminator neural network 3. From this, a reliability score for the correction result of the missing value can be calculated.

For example, the reliability score for the correction result of the missing value may be calculated by using the difference between two probability distributions of the first data set 31 not including missing values and the correction values of missing values of the second data set 32.

As an embodiment, whether to further train the discriminator neural network 3 may be determined based on a reliability score for a correction value of a missing value output from the discriminator neural network 3. That is, when the reliability score for the correction value of the missing value is low, it is determined that the correction value of the missing value is predicted not to be similar to the actual data, and additional learning of the discriminator neural network 3 may be performed. On the other hand, when the reliability score for the correction value of the missing value is high, it is determined that the correction value of the missing value is predicted similarly to the actual data, and additional learning may not be performed.

As described above, according to the method according to the embodiment of the present invention, in correcting the missing value based on the GAN 10, the difference in learning speed between the generator neural network 2 and the discriminator neural network 3 can be reduced by performing pre-training and transfer learning for the generator neural network 2 based on the encoder 11 of the auto encoder 1. Accordingly, the learning of the GAN 10 is properly performed, and reliable correction results of missing values can be obtained.

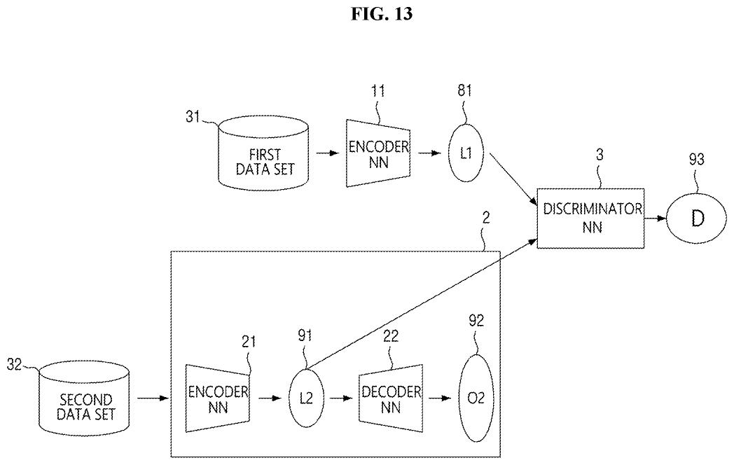

FIG. 13 is an example of an overall learning structure of a GAN according to some embodiments of the present invention. Referring to FIG. 13, the data prediction apparatus 1000 according to an embodiment of the present invention may train the discriminator neural network 3 using data output from the encoder neural network 22 of the generator neural network 2 and the data output from the encoder 11 of the auto encoder 1 as the learning process of the GAN 10.

In the illustrated example, the data output from the encoder neural network 22 of the generator neural network 2 and the data output from the encoder 11 of the auto encoder 1 may be input to the discriminator neural network 3 through the latent layers 91 and 81. As a result of training the discriminator neural network 3, the probability values on whether the data output from the encoder neural network 21 of the generator neural network 2 is distinguished from the data output from the encoder 11 of the auto encoder 1 may be output 93.

As an embodiment, a reliability score for a result output through learning of the generator neural network 2 may be calculated from the learning result of the discriminator neural network 3. As an example, the reliability score can be calculated using the difference between two probability distributions of the data output from the encoder 11 of the auto encoder 1 learned using the first data set 31 not including missing values and the data output from the encoder neural network 22 of the generator neural network 2 learned using the second data set 32.

As an embodiment, whether to further train the discriminator neural network 3 may be determined based on the reliability score output from the discriminator neural network 3. That is, when the reliability score is low, it is determined that the result data output from the generator neural network 2 is predicted not to be similar to the actual data, and additional learning of the discriminator neural network 3 may be performed. On the other hand, when the reliability score is high, it is determined that the result data output from the generator neural network 2 is predicted similarly to the actual data, and additional learning may not be performed.

As described above, according to the method according to the embodiment of the present invention, in predicting data based on the GAN 10, the difference in learning speed between the generator neural network 2 and the discriminator neural network 3 can be reduced by performing pre-learning and transfer learning for the generator neural network 2 based on the encoder 11 of the auto encoder 1. Accordingly, the learning of the GAN 10 is properly performed, and reliable correction results of missing values can be obtained.

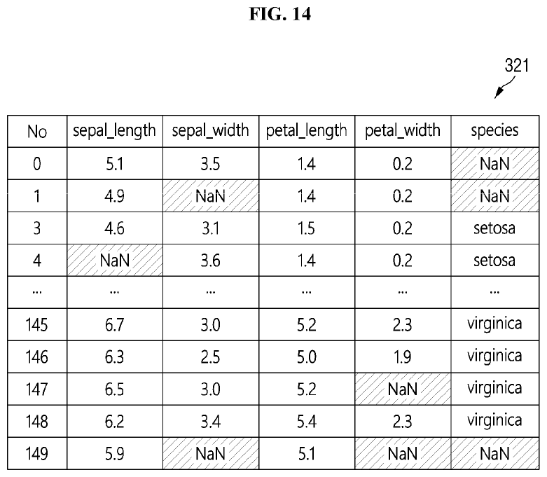

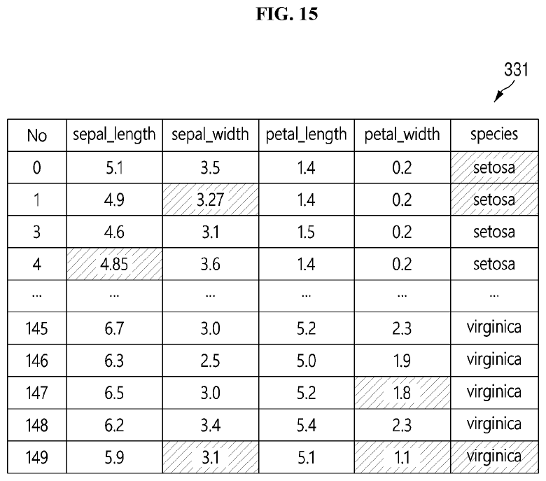

FIGS. 14 and 15 are examples of a data set including a missing value and a data set, in which the missing value is corrected based on the GAN according to some embodiments of the present invention. Referring to FIG. 14, according to the data prediction apparatus 1000 according to the embodiment of the present invention, the data set 331, in which the missing values are corrected, can be obtained by performing the learning of the GAN 10 using the encoder 11 of the auto encoder 1, which is pre-trained for the data set 321 including the missing values, as a generator neural network 2.

At this time, from the learning result of the discriminator neural network 3 of the GAN 10, a reliability score as to whether the correction values of the missing values included in the data set 331 are predicted similarly to the actual data may be calculated. That is, when the reliability score obtained from the learning result of the discriminator neural network 3 is high, it can be determined that the correction values of the missing values included in the data set 331 are predicted similarly to the actual data.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A data prediction method based on generative adversarial network (GAN) performed by a computing device, the method comprising:
pre-training a generator neural network based on an auto encoder structure comprising an encoder and a decoder; and
training a GAN by a transfer learning method, the GAN comprising a discriminator neural network and the pre-trained generator neural network, the training of the GAN by the transfer learning method comprising training the GAN while fixing a decoder neural network of the generator neural network to the pre-trained initial state.

2. The method of claim 1, wherein the pre-training of the generator neural network comprises:
training the auto encoder using a first data set for pre-training among original data.

3. The method of claim 2, wherein the pre-training of the generator neural network comprises:
separating and training a decoder neural network of the auto encoder for each of a categorical variable and a numerical variable.

4. The method of claim 3, wherein the pre-training of the generator neural network comprises:
processing data corresponding to any one type of the categorical variable and the numerical variable as input data for each of a plurality of nodes included in each layer of the decoder neural network.

5. The method of claim 2, wherein the training of the GAN by the transfer learning method comprises:
training the generator neural network based on a result of learning an encoder of the auto encoder using a second data set different from the first data set.

6. The method of claim 1, wherein the training of the GAN while fixing the decoder neural network of the generator neural network to the pre-trained initial state comprises:
fixing a decoder of the auto encoder to an initial state and using as a decoder neural network of the generator neural network.

7. A data prediction method based on a generative adversarial network (GAN) performed by a computing device, the data prediction method comprising:
pre-training a generator neural network based on an auto encoder structure comprising an encoder and a decoder using a first data set not including a missing value; and
training a GAN comprising a discriminator neural network and the pre-trained generator neural network by a transfer learning method using a second data set comprising a missing value, the training of the GAN by the transfer learning method comprising training the GAN while fixing a decoder neural network of the generator neural network to the pre-trained initial state.

8. The method of claim 7, wherein data, in which a missing value is not included among original data, is included as the first data set; and
data, in which a missing value is replaced with a predefined initial value from data comprising the missing value among the original data, is included as the second data set.

9. The method of claim 8, wherein a missing value is replaced by an average value when the missing value included in the second data set is a numerical variable, and the missing value is replaced by a mode value when the missing value is a categorical variable.

10. The method of claim 7, wherein the pre-training of the generator neural network based on the auto encoder structure comprising the encoder and the decoder using the first data set not including the missing value comprises:
separating and training a decoder neural network of the auto encoder for each of a categorical variable and a numerical variable of the first data set.

11. The method of claim 7, wherein the training of the GAN comprising the discriminator neural network and the pre-trained generator neural network by the transfer learning method using the second data set comprising the missing value comprises:
training the generator neural network based on a result of learning an encoder of the auto encoder using the second data set.

12. The method of claim 7, wherein the training of the GAN while fixing the decoder neural network of the generator neural network to the pre-trained initial state comprises:
fixing a decoder of the auto encoder to an initial state and using as a decoder neural network of the generator neural network.

13. A data missing value correction method performed by a computing device, the data missing value correction method comprising:
training a generative adversarial network (GAN) comprising a generator neural network and a discriminator neural network using a first data set not including a missing value and a second data set comprising a missing value; and
obtaining a correction value of a missing value of the second data set output from a generator neural network of the trained GAN, a reliability score for the correction value of the missing value output from a discriminator neural network of the trained GAN and corrected data comprising the first data set.

14. The method of claim 13, wherein the training of the GAN comprises:
pre-training the generator neural network using the first data set.

15. The method of claim 13, wherein the obtaining of the correction value of the missing value of the second data set comprises:
outputting a correction value of the missing value by iterating a process of updating missing values of the second data set a preset number of times during learning of the generator neural network.

16. The method of claim 13, wherein the obtaining of the correction value of the missing value of the second data set comprises:
determining whether to further train the discriminator neural network based on a reliability score for the correction value of the outputted missing value.

17. A data prediction apparatus comprising:
one or more processors;
a communication interface for communicating with an external device;
a memory for loading a computer program performed by the processor; and
a storage for storing the computer program,
wherein the computer program comprises instructions for performing operations comprising:
pre-training a generator neural network based on an auto encoder structure comprising an encoder and a decoder; and
training a GAN comprising a discriminator neural network and the pre-trained generator neural network by a transfer learning method, the training of the GAN by the transfer learning method comprising training the GAN while fixing a decoder neural network of the generator neural network to the pre-trained initial state.

18. The data prediction apparatus of claim 17, wherein the training of the GAN by the transfer learning method comprises:
training the generator neural network based on a result of learning an encoder of the auto encoder.

19. The data prediction apparatus of claim 17, wherein the training of the GAN while fixing the decoder neural network of the generator neural network to the pre-trained initial state comprises:
fixing a decoder of the auto encoder to an initial state and using as a decoder neural network of the generator neural network.

20. The data prediction apparatus of claim 17, wherein the pre-training of the generator neural network comprises:
pre-training the generator neural network by using a first data set not including a missing value,
wherein the training of the GAN by the transfer learning method comprises:
training the GAN by the transfer learning method using the second data set, in which a missing value is replaced with a predefined initial value from data comprising the missing value.
